(19) United States
(12) Patent Application Publication
(10) Pub. No.: US 2026/0179285 A1
(43) Pub. Date: Jun. 25, 2026

(54) IMAGE DATA GENERATION DEVICE, IMAGE DATA GENERATION METHOD, AND STORAGE MEDIUM

(71) Applicant: TOYOTA JIDOSHA KABUSHIKI KAISHA, Toyota-shi (JP)

(72) Inventors: Natsuki FUJII, Nagatuke-shi (JP); Nana TAIE, Toyota-shi (JP); Hiromi SARUWATASHI, Toyota-shi (JP); Juri NAKAMURA, Okazaki-shi (JP)

(73) Assignee: TOYOTA JIDOSHA KABUSHIKI KAISHA, Toyota-shi (JP)

(21) Appl. No.: 19/421,360

(22) Filed: Dec. 16, 2025

(30) Foreign Application Priority Data
Dec. 24, 2024 (JP) 2024-227090

(51) Int. Cl. G06T 11/60

(52) U.S. Cl. CPC G06T 11/60

(57) ABSTRACT

An image data generation device includes a target object acquisition unit configured to acquire a learning target object created as computer graphics (CG), a virtual space generation unit configured to generate a virtual space in which the learning target object is disposed, a background setting unit configured to set a background image captured in a physical space as a background in the virtual space, and an image data generation unit configured to generate image data by using a captured image obtained by imaging the learning target object disposed in the virtual space.

### CROSS-REFERENCE TO RELATED APPLICATION

This application claims priority to Japanese Patent Application No. 2024-227090 filed on Dec. 24, 2024. The disclosure of the above-identified application, including the specification, drawings, and claims, is incorporated by reference herein in its entirety.

### BACKGROUND

### 1. Technical Field

The present disclosure relates to an image data generation device, an image data generation method, and a storage medium that generate image data for machine learning.

### 2. Description of Related Art

Various methods of generating image data for machine learning are known. For example, Japanese Unexamined Patent Application Publication No. 2024-64413 (JP 2024-64413 A) discloses that a plurality of virtual spaces is generated by changing various parameters constituting a virtual space in which a learning target object is disposed. In addition, JP 2024-64413 A discloses that image data is generated by capturing an image of each of the virtual spaces from various positions and directions.

### SUMMARY

A background image in a virtual space used for generating image data for machine learning is usually created as computer graphics (CG). However, it is often difficult to completely reproduce a background in a physical space as CG. Therefore, there is a concern that the accuracy of detecting a learning target object may decrease in the virtual space due to the difference between the background in the physical space and the background image created as CG.

The present disclosure can be implemented as the following aspects.
(1) According to one aspect of the present disclosure, an image data generation device that generates image data for machine learning is provided. The image data generation device includes
a target object acquisition unit configured to acquire a learning target object created as computer graphics,
a virtual space generation unit configured to generate a virtual space in which the learning target object is disposed,
a background setting unit configured to set a background image captured in a physical space as a background in the virtual space, and
an image data generation unit configured to generate the image data by using a captured image obtained by capturing an image of the learning target object disposed in the virtual space.
   With the aspect, since the background setting unit sets the background image captured in the physical space as the background in the virtual space, the physical space can be more faithfully reproduced in the virtual space as compared with a configuration in which the background in the virtual space is created as CG. Therefore, in the virtual space, the accuracy of detecting the learning target object is improved.
(2) In the aspect, the image data generation device further includes a light source adjustment unit configured to adjust a parameter related to a virtual light source disposed in the virtual space, and
the image data generation unit may be configured to generate a plurality of pieces of the image data by using the captured images obtained by capturing images of the learning target object a plurality of times in a state in which positions of the virtual light source are different from each other.
   With the aspect, the image data generation unit generates the pieces of the image data by using the captured images obtained by capturing the images of the learning target object a plurality of times in a state in which the positions of the virtual light source are different from each other. Therefore, the image data can be generated by using various learning target objects having different appearances of shadows in the virtual space. As a result, the learning target object in the physical space can be more faithfully reproduced in the virtual space as compared with a configuration in which the position of the virtual light source is not changed, and the accuracy of detecting the learning target object is further improved in the virtual space.
(3) In the aspect, the light source adjustment unit may be configured to change a position of the virtual light source along a trajectory that is predetermined. With the aspect, since the light source adjustment unit changes the position of the virtual light source along the trajectory that is predetermined, the change in the position of the virtual light source in the physical space can be more faithfully reproduced in the virtual space. Therefore, the change in the appearance of shadow of the learning target object in the physical space can be more faithfully reproduced in the virtual space, and the accuracy of detecting the learning target object is further improved in the virtual space.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram of an image data generation device according to the present embodiment;

FIG. 2 is an explanatory diagram for describing generation of image data by using a virtual space according to the present embodiment; and

FIG. 3 is a flowchart showing a generation procedure of the image data according to the present embodiment.

### DETAILED DESCRIPTION OF EMBODIMENTS

### A. Embodiment

### A1. Configuration of Image Data Generation Device 100:

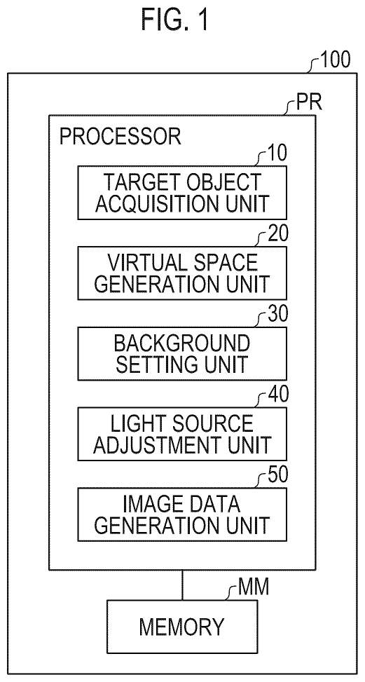

FIG. 1 is a block diagram of an image data generation device 100 according to the present embodiment. The image data generation device 100 generates image data for machine learning. Hereinafter, the image data for machine learning finally obtained is simply referred to as “image data”. The image data according to the present embodiment is used for machine learning in a case where it is automatically determined by image recognition whether a specification of a vehicle satisfies a criterion that is predetermined at a trial production site of the vehicle.

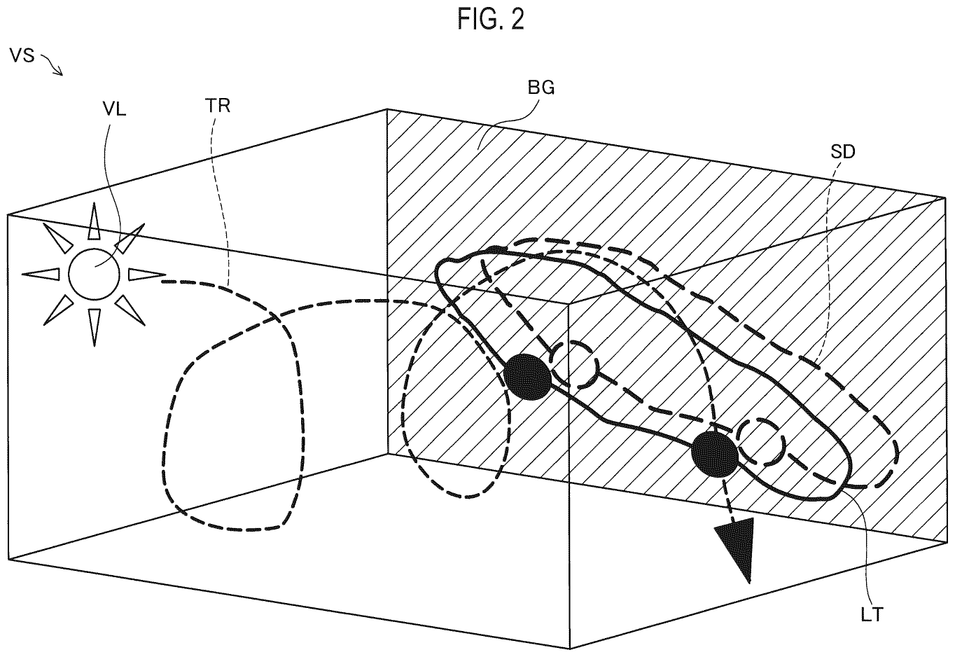

FIG. 2 is an explanatory diagram for describing the generation of the image data by using a virtual space VS according to the present embodiment. As shown in FIG. 2, the image data is generated by using the virtual space VS. A virtual light source VL and a learning target object LT are disposed in the virtual space VS. The learning target object LT disposed in the virtual space VS is imaged each time a position of the virtual light source VL is slightly changed. The imaging here refers to imaging using a virtual camera (not shown) disposed in the virtual space VS. The image data is generated by using the image obtained by such imaging. A detailed generation procedure of the image data will be described below.

As shown in FIG. 1, the image data generation device 100 includes a processor PR and a memory MM. The processor PR executes a program stored in the memory MM in advance to function as a target object acquisition unit 10, a virtual space generation unit 20, a background setting unit 30, a light source adjustment unit 40, and an image data generation unit 50. The memory MM is an example of a storage medium. Hereinafter, each functional unit will be described.

The target object acquisition unit 10 acquires the learning target object LT created as computer graphics (CG).

The virtual space generation unit 20 generates the virtual space VS in which the learning target object LT is disposed. The virtual space generation unit 20 generates the virtual space VS by setting various parameters such as a texture, a color, a position, a size, and an orientation of the learning target object LT in the virtual space VS.

The background setting unit 30 sets the background image actually captured in the physical space as the background BG in the virtual space VS. The “physical space” means a space other than the virtual space VS, that is, a space that physically exists.

The light source adjustment unit 40 adjusts a parameter related to the virtual light source VL disposed in the virtual space VS. More specifically, the light source adjustment unit 40 adjusts a parameter related to properties of light, such as a brightness, a hue, a lightness, and a saturation of light emitted from the virtual light source VL, or a parameter related to the position of the virtual light source VL in the virtual space VS.

The image data generation unit 50 generates the image data. The image data is generated by using the captured image obtained by imaging the learning target object LT disposed in the virtual space VS.

### A2. Image Data Generation Procedure:

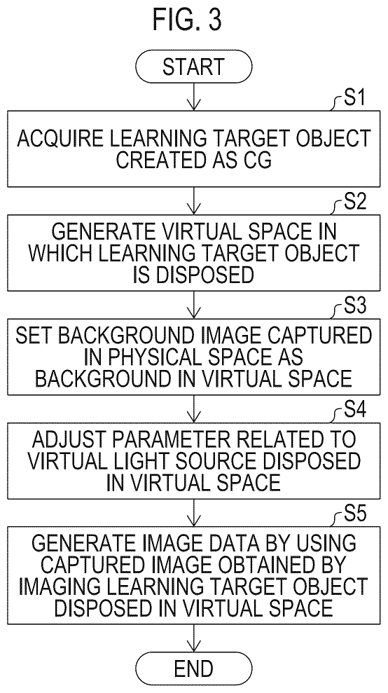

FIG. 3 is a flowchart showing a generation procedure of the image data according to the present embodiment. In a case where the user issues an instruction to execute the generation of the image data in the image data generation device 100, the generation of the image data is started. Hereinafter, S1 to S5 for generating the image data will be described.

In S1, the target object acquisition unit 10 acquires the learning target object LT created as CG. The learning target object LT is created as three-dimensional computer graphics (3D CG). The learning target object LT is created by using a design support tool such as computer aided design (CAD). The learning target object LT according to the present embodiment is a vehicle that is a target of specification inspection at a trial production site of the vehicle.

In S2, the virtual space generation unit 20 generates the virtual space VS in which the learning target object LT created as 3D CG is disposed. The virtual space generation unit 20 sets a parameter related to the texture, the color, or the like of the learning target object LT in the virtual space VS such that the learning target object LT in the physical space can be more faithfully reproduced in the virtual space VS. In addition, the virtual space generation unit 20 sets the position, the size, the orientation, or the like of the learning target object LT in the virtual space VS in accordance with a position, a size, an orientation, or the like of the learning target object LT in a scene where the image recognition is performed.

In S3, the background setting unit 30 sets the background image captured in the physical space as the background BG in the virtual space VS. An image actually captured in a factory that is a trial production site of the vehicle is used as the background image according to the present embodiment.

In S4, the light source adjustment unit 40 adjusts the parameter related to the virtual light source VL disposed in the virtual space VS. In a case where the light emitted from the virtual light source VL is emitted to the learning target object LT, the shadow SD of the learning target object LT is displayed on the background BG. Therefore, the shadow displayed in the physical space can be reproduced in the virtual space VS.

The light emitted from the virtual light source VL according to the present embodiment reproduces sunlight incident into the factory from a window of the factory that is a trial production site. Therefore, the light source adjustment unit 40 sets various parameters related to the properties of the light, such as the brightness, the hue, the lightness, and the saturation of the light emitted from the virtual light source VL, in advance as the “parameter related to the virtual light source VL” based on properties of the sunlight. In addition, the light source adjustment unit 40 sets a trajectory TR of the virtual light source VL based on the temporal change of the sunlight assumed in the physical space and changes the position of the virtual light source VL along the set trajectory TR. As the position of the virtual light source VL is changed, the position of the shadow SD displayed on the background BG is also changed.

It is assumed that the sunlight is incident into the factory from a plurality of windows of the factory or is reflected from the equipment disposed in the factory and is emitted to the learning target object LT. Therefore, the light source adjustment unit 40 sets the trajectory TR of the virtual light source VL in consideration of the plurality of elements. As shown in FIG. 3, the light source adjustment unit 40 according to the present embodiment sets a spiral trajectory TR and changes the virtual light source VL along the trajectory TR. The trajectory TR of the virtual light source VL is set based on, for example, a result obtained by simulating the temporal change of the sunlight emitted to the learning target object LT in the physical space.

In S5, the learning target object LT disposed in the virtual space VS is imaged each time the position of the virtual light source VL is slightly changed. That is, the learning target object LT is imaged a plurality of times in a state in which positions of the virtual light source VL are different from each other. The image data generation unit 50 generates a plurality of pieces of the image data by using a plurality of captured images obtained by imaging the learning target object LT disposed in the virtual space VS. Captured images are generated into final image data through processing such as brightness correction and trimming. The generated pieces of image data are used to construct an image recognition system using machine learning.

According to the image data generation device 100 described above, the background setting unit 30 sets the background image actually captured in the physical space as the background BG in the virtual space VS. Therefore, the physical space can be more faithfully reproduced in the virtual space VS as compared with a configuration in which the background BG in the virtual space VS is created as CG. Therefore, the accuracy of detecting the learning target object LT in the virtual space VS is improved.

In addition, the image data generation unit 50 generates the pieces of image data by using the captured images obtained by imaging the learning target object LT a plurality of times in a state in which positions of the virtual light source VL are different from each other. Therefore, the image data can be generated by using various learning target objects LT having different appearances of the shadows SD in the virtual space VS. Therefore, the learning target object LT in the physical space can be more faithfully reproduced in the virtual space VS as compared with a configuration in which the position of the virtual light source VL is not changed, and the accuracy of detecting the learning target object LT in the virtual space VS is further improved.

In addition, since the light source adjustment unit 40 changes the position of the virtual light source VL along the trajectory TR that is predetermined, the change in the position of the virtual light source VL in the physical space can be more faithfully reproduced in the virtual space VS. Therefore, the change in the appearance of the shadow SD of the learning target object LT in the physical space can be more faithfully reproduced in the virtual space VS, and the accuracy of detecting the learning target object LT in the virtual space VS is further improved.

### B. Other Embodiments

(B1) In the present embodiment, the learning target object LT is a vehicle that is a target of specification inspection at a trial production site of the vehicle. The background image actually captured in the factory that is the trial production site of the vehicle is used as the background BG in the virtual space VS. However, the present disclosure is not limited thereto. The type of the learning target object LT is optionally selected in accordance with a target to be subjected to the image recognition. In addition, the background image set as the background BG is optionally selected in accordance with a location where the image recognition of the learning target object LT is performed. As described above, the image data generation device 100 may be used in various scenes where the image data for machine learning is generated.
(B2) In the present embodiment, the target object acquisition unit 10 acquires the learning target object LT created as CG, but the present disclosure is not limited thereto. The target object acquisition unit 10 may have a function of creating the learning target object LT as CG.
(B3) In the present embodiment, the light source adjustment unit 40 changes the position of the virtual light source VL along the trajectory TR that is predetermined, but the present disclosure is not limited thereto. For example, the light source adjustment unit 40 may randomly change the position of the virtual light source VL. Even in this case, the image data can be generated by using various learning target objects LT having different appearances of the shadows SD as compared with a configuration in which the position of the virtual light source VL is not changed.
(B4) In the present embodiment, one virtual light source VL is disposed in the virtual space VS, but the present disclosure is not limited thereto. It is also assumed that the sunlight incident into the factory is emitted to the learning target object LT from a plurality of directions by being reflected from the equipment disposed in the factory. In this case, two or more virtual light sources VL may be set in the virtual space VS. In addition, each of the positions of the two or more virtual light sources VL may be changed along the trajectory TR that is predetermined.
(B5) In the present embodiment, various parameters related to the properties of the light, such as the brightness, the hue, the lightness, and the saturation of the light emitted from the virtual light source VL, are predetermined based on the properties of the sunlight, but the present disclosure is not limited thereto. Since the parameters related to the properties of the sunlight, such as the brightness and the hue, actually changes depending on the time of day, the parameters related to the properties of the light, such as the brightness and the hue, emitted from the virtual light source VL may be changed in accordance with the parameters related to the properties of the sunlight.
(B6) In the present embodiment, the image data generation device 100 includes the light source adjustment unit 40, but the present disclosure may omit the light source adjustment unit 40. For example, in a case where it is assumed that the sunlight incident into the factory is not considered and only light emitted from the lighting equipment disposed in the factory is assumed to be emitted to the learning target object LT, it is not necessary to adjust various parameters of the virtual light source VL. Therefore, the light source adjustment unit 40 can be omitted.
(B7) In the present embodiment, the image data is generated in the order of S1 to S5, but the present disclosure is not limited thereto. For example, the virtual space generation unit 20 may set the parameter related to the learning target object LT in the virtual space VS after the light source adjustment unit 40 sets the parameter related to the virtual light source VL. In addition, the learning target object LT created as CG may be disposed in the virtual space VS after the background BG in the virtual space VS is set.

The present disclosure can be implemented in various aspects, for example, an image data generation method or a computer program, in addition to the aspect as the image data generation device 100.

The present disclosure is not limited to the embodiments, and can be implemented with various configurations without departing from the gist of the present disclosure. For example, the technical features in the embodiment corresponding to the technical features in each of the aspects described in the section of the summary of the disclosure can be appropriately substituted or combined in order to solve a part or all of the problems. Alternatively, the technical features may be appropriately substituted or combined in order to achieve a part or all of the effects. In addition, in a case where the technical features are not described as essential in the present specification, the features can be appropriately deleted.

What is claimed is:

1. An image data generation device that generates image data for machine learning, the image data generation device comprising:
a target object acquisition unit configured to acquire a learning target object created as computer graphics;
a virtual space generation unit configured to generate a virtual space in which the learning target object is disposed;
a background setting unit configured to set a background image captured in a physical space as a background in the virtual space; and
an image data generation unit configured to generate the image data by using a captured image obtained by capturing an image of the learning target object disposed in the virtual space.

2. The image data generation device according to claim 1, further comprising a light source adjustment unit configured to adjust a parameter related to a virtual light source disposed in the virtual space,
wherein the image data generation unit is configured to generate a plurality of pieces of the image data by using the captured images obtained by capturing images of the learning target object a plurality of times in a state in which positions of the virtual light source are different from each other.

3. The image data generation device according to claim 2, wherein the light source adjustment unit is configured to change a position of the virtual light source along a trajectory that is predetermined.

4. An image data generation method of generating image data for machine learning, the image data generation method comprising:
acquiring a learning target object created as computer graphics;
generating a virtual space in which the learning target object is disposed;
setting a background image captured in a physical space as a background in the virtual space; and
generating the image data by using a captured image obtained by capturing an image of the learning target object disposed in the virtual space.

5. A non-transitory storage medium storing a computer program for generating image data for machine learning, the computer program causing a computer to implement:
a function of acquiring a learning target object created as computer graphics;
a function of generating a virtual space in which the learning target object is disposed;
a function of setting a background image captured in a physical space as a background in the virtual space; and
a function of generating the image data by using a captured image obtained by capturing an image of the learning target object disposed in the virtual space.
